(19) United States
(12) Patent Application Publication
(10) Pub. No.: US 2014/0265202 A1
(43) Pub. Date: Sep. 18, 2014

(54) STEERING KNUCKLE

(71) Applicant: KW AUTOMOTIVE NORTH AMERICA, INC., Sanger, CA (US)

(72) Inventors: Robert Daniel Bunker, Sanger, CA (US); Dallas Wayne Brandt, Sanger, CA (US); Michael K. Kojima, Cypress, CA (US)

(73) Assignee: KW AUTOMOTIVE NORTH AMERICA, INC., Sanger, CA (US)

(21) Appl. No.: 13/826,528

(22) Filed: Mar. 14, 2013

(51) Int. Cl. B62D 7/18

(52) U.S. Cl. CPC B62D 7/18
USPC 280/93.512

(57) ABSTRACT

The present invention provides improved aftermarket vehicle lowering steering knuckles that are superior to existing aftermarket steering knuckles because they are capable of lowering a vehicle while maintaining or improving vehicle handling, increasing caster, and improving alignment capabilities. Embodiments of the vehicle lowering steering knuckles of the present invention improve handling characteristics by adding caster angle into the steering knuckle, allowing the original caster specifications to be increased without changing the forward or aft locations of the vehicle wheels. This is achieved by adjusting the mounting location of the upper ball joint laterally so that the mounting points are adjusted without affecting the front wheel placement. Embodiments of the vehicle lowering steering knuckles of the present invention also increase vehicle lowering capacity by increasing the downward angle of the upper ball joint mount.

### BACKGROUND OF THE INVENTION

1. Field of Invention The present invention relates to after-market vehicle-lowering steering knuckles (drop spindles), and more particularly to a newly designed drop spindle which provides improved handling characteristics, increased caster, and which allows a vehicle equipped with such a steering knuckle to be aligned for performance handling.

2. Description of the Related Art

A typical spindle (or steering knuckle) is a component of the front suspension of a vehicle, which attaches the wheel and brake assemblies to the vehicle, and allows the wheels to travel vertically (oust and rebound), turn, and rotate. The most common spindle bodies are of a cast metal configuration utilizing a metallic, machined, cylindrical shaft called a spindle pin to which the wheel bearings, brake components, and wheel are affixed. In particular, a wheel hub fits over the elongated spindle pin with bearing surfaces actually making contact with the pin. A vehicle wheel is, in turn, attached to the hub. This common type of pin and hub assembly is sometimes referred to in the industry as a “dead hub”.

For aesthetic purposes, it is common to lower the chassis of a vehicle closer to the ground by vertically repositioning the elongated spindle pin, steering arm and brake attachment features on the steering knuckle assembly. In this regard, numerous vehicle lowering steering knuckles (commonly known as “drop” spindles) have been developed in which the position of the spindle pin shaft has been vertically changed relative to the steering knuckle body, thereby raising the position of the vehicle wheels relative to the chassis which lowers the chassis closer to the ground. This is possible because most drop spindle bodies are large enough that there is considerable space within the body, often several inches, where the position of the elongated spindle pin can be established without affecting performance.

When modifying a vehicle for performance driving applications, wheel alignment becomes critical. Often a vehicles alignment is set for comfort rather than performance driving as originally equipped. Typically, wheel placement suffers because the vehicle lowering steering knuckle causes the front wheels to be moved forward or aft, thereby affecting driving performance. Alignment modifications may not be possible to a vehicle using standard vehicle lowering steering knuckles; and when such alignment modifications are possible, the results are often unacceptable. Typically the use of a vehicle lowering steering knuckle causes one aspect of wheel alignment to be sacrificed to achieve another.

Currently, vehicle lowering steering knuckles only address lowering of the vehicle without attempting to provide additional features that would allow for the vehicle to be aligned for higher performance handling. Most existing vehicle lowering steering knuckles have attempted to duplicate the original mounting locations of the steering knuckle while moving the spindle or hub assembly vertically to lower vehicle height. Other vehicle lowering spindles have modified the mounting locations to allow for the lowered spindle or hub to not interfere with the mounting points. With existing vehicle lowering steering knuckles, in order to add additional caster angle to the vehicle requires the wheel locations of the vehicle to be moved forward or aft. The drop spindle of U.S. Pat. No. 6,860,498 and the BellTech 2509 model are typical of such existing steering knuckles.

There continues to be a need, therefore, for an improved steering knuckle designed to lower a vehicle while maintaining or improving vehicle handling, increasing caster and improving alignment capabilities.

### SUMMARY OF THE INVENTION

The improved vehicle lowering steering knuckles of the present invention are superior to existing vehicle lowering steering knuckles because they are capable of lowering a vehicle while maintaining or improving vehicle handling, increasing caster, and improving alignment capabilities. Among other things, the vehicle lowering steering knuckles of the present invention improve handling characteristics by adding caster angle (an additional degree of caster) into the steering knuckle, allowing the original caster specifications to be increased without changing the forward or aft locations of the vehicle wheels. This is achieved by adjusting the mounting location of the upper ball joint laterally or horizontally so that the mounting points are adjusted without affecting the front wheel placement. In addition, in embodiments of the present invention, the downward angle of the upper ball joint mount is increased, thereby allowing for additional lowering of the vehicle chassis, especially when used in conjunction with an adjustable shock or strut, such as that disclosed in U.S. Pat. No. 8,070,171.

With existing steering knuckles, in order to change the caster angle in the vehicle, the upper ball joint itself is moved forward or aft. This movement of the upper ball joint necessarily results in moving the location of the vehicle wheels, which can negatively affect vehicle performance and handling. In embodiments of the present invention, the mount for the upper ball joint is provided in a different location than that of factory or other steering knuckles. This position is laterally or horizontally offset from center by pre-determined distance. This offset builds in a pre-determined amount of caster when the ball joint is attached to this mount. Thus, by way of example and without limiting the embodiments or claims of the present invention, if the position of the upper ball joint mount in a factory steering knuckle provides five degrees (5°) of caster, the offset location of the upper ball joint mount in embodiments of the present invention may provide, for example, six degrees (6°) of caster without changing the location of the vehicle wheels. Thus, installation of such a steering knuckle will automatically provide increased caster. It is to be appreciated that the amount of caster provided is directly related to the amount of offset of the upper ball joint mount from the normal, factory (usually centered) position.

The steering knuckles of the present invention also optimize the upper ball joint mounting location, lower ball joint mounting location, and steering tie rod mounting location in relation to one another allowing the vehicle to be aligned for higher performance handling and improved characteristics. Among other things, the angle of the upper ball joint mount has been adjusted to decrease the relative angle of the upper control arm to the upper ball joint boss. This adjustment also modifies the alignment camber because of arc made by the ball joint as the mounting angle is changed.

The steering knuckles of the present invention also provide improved alignment capabilities by adjusting the locations of the ball joint boss and ball joint mounting provision along the plane that represents forward and aft on the vehicle so that the steering knuckles are be in a straight position.

Existing steering knuckles may allow a vehicle to be lowered by approximately two inches (2″). Further lowering places the upper control arm at more of an angle with respect to the upper ball joint mount. However, in embodiments of the steering knuckles of the present invention, the increased downward angle of the upper ball joint mount allows the control arm to have a greater downward angle, allowing the vehicle to be lowered by more than two inches. Thus, these embodiments may be used with adjustable struts such as those disclosed in U.S. Pat. No. 8,070,171 to lower the height of a vehicle by as much as three to five inches.

It is therefore an object of the present invention to provide a vehicle lowering steering knuckle with increased caster built into the spindle for optimized driving characteristics.

It is also an object of the present invention to provide a vehicle lowering steering knuckle that provides an additional degree of caster without the wheel location moving forward or aft on the vehicle.

It is a further object of the present invention to provide improved alignment capabilities through lateral adjustment of the location of the upper ball mount relative to an existing or factory location for this mount.

It is a further object of the present invention to provide increased vehicle lowering capability through adjustment of the angle of the upper ball joint mount.

It is a further object of the present invention to increased vehicle lowering capability through use of embodiments of the present invention with adjustable shock absorbers and struts.

Additional objects of the invention will be apparent from the detailed description and the claims herein.

### BRIEF DESCRIPTIONS OF THE DRAWINGS

FIG. 1 is a side view of a prior art vehicle-lowering steering knuckle showing typical positions for upper and lower ball joint mounts.

FIG. 2 is a side view of an embodiment of a vehicle-lowering steering knuckle of the present invention showing the laterally off-center placement of the upper ball joint mount.

FIG. 2A is a close up view of the embodiment of FIG. 2.

FIG. 3 is a front perspective view of the embodiment of FIG. 1.

FIG. 4 is a rear perspective view of the embodiment of FIG. 1.

FIG. 5 is a side view of a prior art vehicle-lowering steering knuckle showing a typical angle for the upper ball joint mount.

FIG. 6 is a side view of an embodiment of a vehicle-lowering steering knuckle of the present invention showing the increased downward angle of the upper ball joint mount.

FIG. 7 is a side view of a prior art vehicle-lowering steering knuckle with a shock absorber showing approximately two inches of lowering in a vehicle.

FIG. 8 is a side view of a an embodiment of a vehicle-lowering steering knuckle of the present invention with a shock absorber showing approximately five inches of lowering in a vehicle.

### DETAILED DESCRIPTION

Referring to the drawings wherein like reference characters designate like or corresponding parts throughout the several views, and referring particularly to FIGS. 2-4, it is seen that the illustrated embodiment of the present invention includes a steering knuckle having a cast body 21 with a large-diameter circular bore 25 centrally located therein for receiving a wheel hub assembly. The steering knuckle 21 includes three bolt openings 26, 27 and 28 for receiving corresponding bolt assemblies of the wheel hub. Referring to FIG. 2, it is seen that cast body 21 of the illustrated embodiment includes an upper ball joint mount 30, a lower ball joint mount 32, a steering arm attachment tab 38, and tabs 36 with openings 37 therein for attachment of the brake caliper to the steering knuckle body.

Referring to the side view of FIG. 2, it is seen that upper ball joint mount 30 is located at the top of the steering knuckle body 21, on the opposite side of bolt opening 28 from bore 25.

Upper mount 30 includes a bore 71 there through that may or may not be tapered to be narrower at the bottom near bore 25 and wider at the top. Bore 71 receives the stud 74 of the upper ball joint assembly. Stud 74 may also tapered to correspond to bore 71. A ball 77 is provided at the opposite end of stud 74 for engagement with a mating socket in the upper control arm 101.

It is to be appreciated that bolt opening 28, central bore 25 and the lower ball joint mount 32 are all aligned along axis A which defines a centerline through the steering knuckle body 21. In the prior art steering knuckle of FIG. 1, bore 71 is also provided along this same axis. However, in embodiments of the present invention, bore 71 in upper ball joint mount 30 is not aligned with axis A, but is instead laterally or horizontally offset backward of axis A, along a parallel axis B. See FIG. 2A. Gap C defines the distance between axis A and axis B. The size of gap C affects the angle or caster of the steering knuckles of the present invention, and may be of any suitable size from between about 3 to about 8 millimeters (3 mm-8 mm), preferably between about 4 to about 6 millimeters (4 mm-6 mm), and optimally around 4.8 mm, to provide approximately one additional degree (1°) of caster when an upper ball joint is mounted to the offset bore 71. Different amounts of additional caster may be desired by different individuals for use with different vehicles, so in different embodiments of the invention, gap C may be sized according to the amount of additional caster desired. It is to be appreciated that the larger the size of gap C, the greater the degree of additional caster provided by the steering knuckle; and the smaller the size of gap C, the lesser the degree of additional caster provided.

Turning to the illustrated embodiment of FIG. 6, it is seen that the upper ball joint mount 30 is not provided at a perpendicular 90° angle from the plane defined by the edge of bore 25, but instead is tilted downward at an acute angle. This angular orientation allows the ball joint associated with this mount to be easily attached to the upper control arm 101. Comparing the prior art steering knuckle of FIG. 5 to the exemplary embodiment of the present invention shown in FIG. 6, it is seen that the downward angle of the upper ball joint mount 30 in FIG. 6 is greater than that of the prior art in FIG. 5. The downward angle “x” of the prior art mount 30 of FIG. 5 is approximately 11°, whereas the downward angle “y” of mount 30 of the exemplary embodiment of FIG. 6 is approximately 16°. This increased downward angle allows the downward angle of upper control arm 101 to also be increased, thereby allowing the vehicle to be lowered by an additional one to three inches (1″-3″), depending on the amount of downward angle. Different angles will provide different amounts of lowering capacity, with smaller angles providing less lowering and larger angles providing more lowering. The lowering angle may range from about 11° to about 20°, with an optimum angle around 16°.

Embodiments which employ the increased downward angle of upper ball joint mount 30 may take advantage of the increased lowering capability by using an adjustable strut, lowering spring, or shock absorber such as those disclosed in U.S. Pat. No. 8,070,171. The angle of upper control arm 101 may be optimally positioned by setting the height of the adjustable shock absorber to complement the angle of the upper ball joint mount 30 of these embodiments of the present invention.

An embodiment of the steering knuckle of the present invention is illustrated in FIG. 8 along with a shock absorber 41 and lower control arm 102 This embodiment is compared to a prior art steering knuckle with shock absorber in FIG. 7. Many components of these assemblies are omitted from these drawings including without limitation the ball joints themselves. The downward angle of upper ball joint mount 30 shown in FIG. 8 allows embodiments of the present invention to be used with different shock absorbers (including without limitation those disclosed in U.S. Pat. No. 8,070,171) to achieve additional vehicle lowering than previously available with prior art steering knuckles. FIGS. 7 and 8 are aligned to more graphically illustrate the difference in vehicle lowering that can be achieved using embodiments of the present invention.

The after-market steering knuckle of the present invention is designed to replace other or factory-supplied steering knuckles, allowing the vehicle to be lowered closer to the ground while also improving caster and other performance characteristics. In some embodiments, the upper ball joint mount is positioned laterally off center as compared with other or factory-provided steering knuckles. In accordance with these embodiments of the present invention, this lateral change in position of the upper ball joint mount gives the steering knuckle additional built-in caster of up to approximately one additional degree (up to 1°), so that when it is installed, this additional caster is achieved without changing the fore or aft positions of the wheels. In other embodiments, the upper ball joint mount is tilted downward at an angle that is greater than that of other or factory-supplied steering knuckles. In accordance with these embodiments of the present invention, this downward angle allows increased vehicle lowering capability. Some embodiments of the present invention incorporate both the offset position and the increased downward angle of the upper ball joint mount to provide both effects (increased caster and further lowering capability) from the same steering knuckle.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A vehicle-lowering steering knuckle comprising
a body member having a large centrally located opening therein for receiving a wheel hub assembly, said body member having a central axis therethrough,
an upper ball joint mount having a bore therein, and
a lower ball joint mount having a bore therein, wherein the bore of said upper ball joint mount is laterally offset from said central axis.

2. The steering knuckle of claim 1 wherein said offset is between about 3 millimeters and about 8 millimeters from said central axis.

3. The steering knuckle of claim 1 wherein said offset is between about 4 millimeters and about 6 millimeters from said central axis.

4. The steering knuckle of claim 1 wherein said offset is about 5 millimeters from said central axis.

5. The steering knuckle of claim 1 wherein said offset is about 4.8 millimeters from said central axis.

6. The steering knuckle of claim 1 wherein said upper ball joint mount is laterally offset from said central axis.

7. A vehicle-lowering steering knuckle comprising
a body member having a large centrally located opening therein for receiving a wheel hub assembly, an edge of said opening defining a longitudinal plane for said body member,
an upper ball joint mount having a bore therein, and
a lower ball joint mount having a bore therein, wherein said upper ball joint mount protrudes out from said body member at a downward angle of more than 11°.

8. The steering knuckle of claim 5 wherein said downward angle is between about 11° and about 20°.

9. The steering knuckle of claim 5 wherein said downward angle is approximately 16°.

10. A vehicle-lowering steering knuckle comprising
a body member having a large centrally located opening therein for receiving a wheel hub assembly, said body member having a central axis therethrough, and an edge of said opening defining a longitudinal plane for said body member,
an upper ball joint mount having a bore therein, and
a lower ball joint mount having a bore therein, wherein the bore of said upper ball joint mount is laterally offset from said central axis and wherein said upper ball joint mount protrudes out from said body member at a downward angle of more than 11°.

11. The steering knuckle of claim 10 wherein said offset is between about 3 millimeters and about 8 millimeters from said central axis.

12. The steering knuckle of claim 10 wherein said offset is between about 4 millimeters and about 6 millimeters from said central axis.

13. The steering knuckle of claim 10 wherein said offset is about 5 millimeters from said central axis.

14. The steering knuckle of claim 10 wherein said offset is about 4.8 millimeters from said central axis.

15. The steering knuckle of claim 10 wherein said upper ball joint mount is laterally offset from said central axis.

16. The steering knuckle of claim 10 wherein said downward angle is between about 11° and about 20°.

17. The steering knuckle of claim 10 wherein said downward angle is approximately 16°.
